(19) United States
(12) Patent Application Publication
(10) Pub. No.: US 2003/0017254 A1
(43) Pub. Date: Jan. 23, 2003

(54) Trail mix tenders

(76) Inventor: Jeffrey Michael Fulbright, Oshkosh, WI (US)

Correspondence Address: Jeffrey Michael Fulbright, 667 Bowen St., Oshkosh, WI, 54902, US

(21) Appl. No.: 09/902,860

(22) Filed: Jul. 11, 2001

(51) Int. Cl. A23L 1/31

(52) U.S. Cl. 426/646

(57) ABSTRACT

“Trail Mix Tenders” are formed, smokehouse dried, snack meat food products nutritionally enhanced by the inclusion of both dried fruits and/or crushed nuts or seeds. The inclusion of these nutritional adjuncts is achieved in the pre-smokehouse preparation of the meat. The selected meat is placed into a grinder/mixer with seasonings and a chosen fruit/nut/seed combination in a ratio of between 20%-40% adjunct to 60%-80% protein (meat). Mixture is left to “set” approximately 8 hours. It is then processed by extruding the blended materials through a flattened “horn” forming individual strips/sticks. These are then placed into a heated smokehouse and smoked/cooked to an internal temperature of 175 degrees and a moisture to protein ratio of 1.9-1.0.

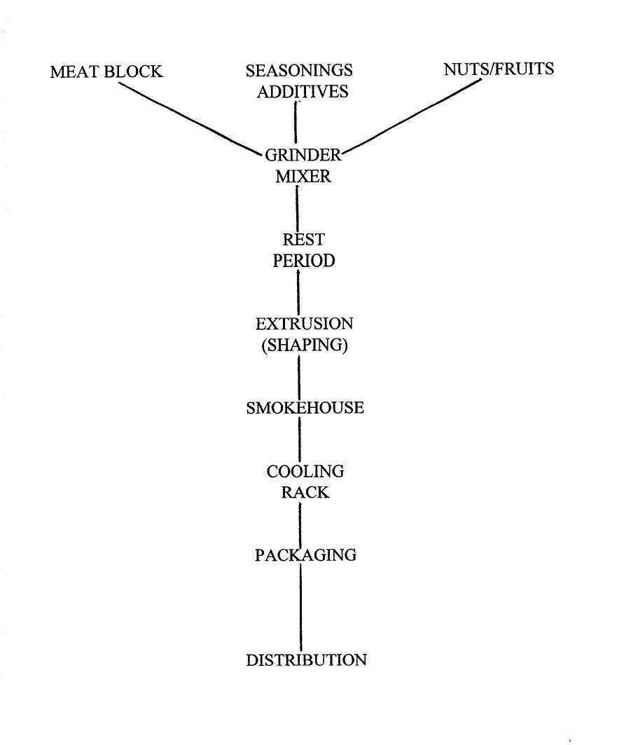

The basis of the patent application for a food product known as Trail Mix Tenders is the composition developed to create this new product form.

Trail Mix Tenders are ground and formed, smokehouse dried, snack meat food products nutritionally enhanced by the inclusion of both dried fruits and crushed nuts or seeds. The inclusion of these nutritional adjuncts is achieved in the pre-smokehouse preparation of the meat. The selected meat is placed into a grinder/mixer with dry ingredients (seasonings and additives) and the fruit and nut/seed combination. It is then thoroughly mixed for even distribution of all ingredients. This mixture is left to “set” for approximately 8 hours. It is then processed by extruding the blended materials through a flattened “horn” forming individual strips (Tenders) approximately 7″ long×1″ wide weighing approximately 1 ounce. The strips are then placed into a heated smokehouse and smoked/cooked to an internal temperature of 175 degrees. After the smoking process, the strips are air cooled and individually packaged. Packaging is of a vacuum type, allowing for a shelf stable product with a minimum expiration period of six months with no refrigeration. The total process results in a snack meat “Tender” with a moisture to protein ratio of 1.9 to 1.0, producing a pleasantly dried yet tender “formed” snack meat. The addition of the fruit results in a release of natural fruit sugars which permeate the product with a slight sweetness unlike any traditional dried snack meats. The further inclusion of crushed nuts provides not only a visual impact by their presence but imbues an additional flavor characteristic with a slightly “crunchy” nut accent.

The current state of the art for snack meats of this type (dried, kippered, jerky) consists of numerous seasoning oriented flavor styles such as “Spicey,” “Peppered,” “Smokey,” and “Teriyaki,” etc. It, however, fails to provide inclusions other than seasonings for variation. The Trail Mix Tenders composition not only fills the need for the ability to provide greater flavor variety, it also addresses the importance of nutritional function. Dried fruit and nut inclusions provide substantial additional nutrient factors (vitamins, minerals, antioxidants, essential fatty acids, fiber, phytochemicals) not available in any other snack meat.

With current and growing consumption of healthier more nutritious foods and the public's love of convenience/snack products, the market potential for the Trail Mix Tender composition is tremendous. Snack meats alone generate in excess of 1.2 billion dollars in annual sales according to “Information Resources Inc.” A nutritionally superior snack meat would only serve to generate greater interest in this segment.

INGREDIENT BREAKDOWN

| | |
|---|---|
| Meat | 74.6%-54.6% |
| Fruit | 10.0%-20.0% |
| Nut/Seed | 10.0%-20.0% |
| Salt | 2.03% |
| Corn syrup solid | 1.67% |
| Dextrose | (.81%) |
| Spices | (.73%) |
| Maple Sugar | (.06%) |
| Sugar | (.05%) |
| Sodium Erythorbate | (.04%) |
| Sodium Nitrite | (.012%) |
| TOTAL | 100.00% (by weight) |

1. Prior to this new process and composition, no ground and/or formed snack meats (strips/sticks) have ever contained dried fruit and/or nuts or seeds as inclusive ingredients.

2. This new process produces the first nutritionally enhanced snack meat product.
